(19) United States
(12) Patent Application Publication
(10) Pub. No.: US 2026/0175564 A1
(43) Pub. Date: Jun. 25, 2026

(54) LIQUID EJECTING APPARATUS AND HEAD UNIT

(71) Applicant: SEIKO EPSON CORPORATION, Tokyo (JP)

(72) Inventors: Kyo HORIE, Okaya (JP); Koichi KASHU, Shiojiri (JP); Toru MATSUYAMA, Matsumoto (JP)

(21) Appl. No.: 19/430,384

(22) Filed: Dec. 23, 2025

(30) Foreign Application Priority Data
Dec. 25, 2024 (JP) 2024-228725

(51) Int. Cl. B41J 2/045; B41J 2/14; B41J 29/377

(52) U.S. Cl. CPC B41J 2/04515; B41J 2/04541; B41J 2/04548; B41J 2/0455; B41J 2/04581; B41J 2/14233; B41J 29/377

(57) ABSTRACT

A liquid ejecting apparatus includes: an ejection section that is driven by a drive signal and ejects liquid; a circuit substrate on which a drive circuit that generates the drive signal is disposed; a heatsink that cools the drive circuit; and a clay-like thermally conductive member having an electrical insulation property. The thermally conductive member includes a base material made of silicone clay, and a thermally conductive particle added to the base material, and is in contact with the drive circuit and the heatsink.

The present application is based on, and claims priority from JP Application Serial Number 2024-228725, filed December 25, 2024, the disclosure of which is hereby incorporated by reference herein in its entirety.

### BACKGROUND

### 1. Technical Field

The present disclosure relates to a liquid ejecting apparatus and a head unit.

### 2. Related Art

There is known a liquid ejecting apparatus including a drive circuit that generates a drive signal, and an ejection section that is driven by the drive signal and ejects liquid. In the liquid ejecting apparatus, since the drive signal for driving the ejection section has a large amplitude, the drive circuit generates heat at the time of the generation of the drive signal, and the temperature of the drive circuit becomes high. Therefore, various configurations for cooling the drive circuit have been proposed. For example, JP-A-2023-022515 discloses a configuration in which heat generated from a drive circuit is dissipated by a heatsink having a shape corresponding to the height of an electronic component included in the drive circuit.

However, according to the related art, the heatsink may have a complex shape in order to efficiently cool the drive circuit. Therefore, according to the related art, for example, there is a possibility that the load for manufacturing a configuration for cooling the drive circuit may increase or the cost of manufacturing the configuration for cooling the drive circuit may increase.

### SUMMARY

To solve the above-described problems, according to an aspect of the present disclosure, there is provided a liquid ejecting apparatus including: an ejection section that is driven by a drive signal and ejects liquid; a circuit substrate on which a drive circuit that generates the drive signal is disposed; a heatsink that cools the drive circuit; and a clay-like thermally conductive member having an electrical insulation property, wherein the thermally conductive member includes a base material made of silicone clay, and a thermally conductive particle added to the base material, and is in contact with the drive circuit and the heatsink.

According to another aspect of the present disclosure, there is provided a head unit including: an ejection section that is driven by a drive signal and ejects liquid; a circuit substrate on which a drive circuit that generates the drive signal is disposed; a heatsink that cools the drive circuit; and a clay-like thermally conductive member having an electrical insulation property, wherein the thermally conductive member includes a base material made of silicone clay, and a thermally conductive particle added to the base material, and is in contact with the drive circuit and the heatsink.

### BRIEF DESCRIPTION OF THE DRAWINGS

FIG. 1 is a block diagram illustrating an example of a configuration of an ink jet printer according to an embodiment of the present disclosure.

FIG. 2 is a perspective view illustrating an example of a schematic internal structure of the ink jet printer.

FIG. 3 is a cross-sectional view illustrating an example of a structure of an ejection section.

FIG. 4 is a block diagram illustrating an example of a configuration of a head unit.

FIG. 5 is a timing chart illustrating an example of signals supplied to the head unit.

FIG. 6 is an explanatory diagram illustrating an example of an individual specifying signal.

FIG. 7 is a block diagram illustrating an example of a configuration of a drive signal generating circuit.

FIG. 8 is a plan view illustrating the example of the configuration of the drive signal generating circuit.

FIG. 9 is a cross-sectional view illustrating an example of a structure of a drive signal generation unit.

FIG. 10 is a plan view illustrating the example of the structure of the drive signal generation unit.

FIG. 11 is a schematic diagram illustrating an example of an outline of thermally conductive clay.

FIG. 12 is a cross-sectional view illustrating an example of a structure of a drive signal generation unit according to a first modification of the present disclosure.

FIG. 13 is a cross-sectional view illustrating an example of a structure of a drive signal generation unit according to a second modification of the present disclosure.

FIG. 14 is a cross-sectional view illustrating an example of a structure of a drive signal generation unit according to a third modification of the present disclosure.

FIG. 15 is a block diagram illustrating an example of a configuration of a drive signal generating circuit according to a fourth modification of the present disclosure.

FIG. 16 is a cross-sectional view illustrating an example of a structure of a drive signal generation unit according to the fourth modification of the present disclosure.

FIG. 17 is a plan view illustrating an example of a structure of an ink jet printer according to a fifth modification of the present disclosure.

FIG. 18 is a block diagram illustrating an example of a structure of an ink jet printer according to a sixth modification of the present disclosure.

### DESCRIPTION OF EMBODIMENTS

Hereinafter, embodiments for carrying out the present disclosure will be described with reference to the drawings. However, in each drawing, the dimensions and scale of each section are appropriately different from the actual ones. In addition, since the embodiments described below are suitable specific examples of the present disclosure, the embodiments include various technically preferable limitations, but the scope of the present disclosure is not limited to the embodiments unless otherwise stated in the following description to particularly limit the present disclosure.

### A. Embodiments

A liquid ejecting apparatus will be described below using, as an example, an ink jet printer 1 that ejects ink to form an image on a recording sheet PP.

### A.1. Overview of Ink Jet Printer 1

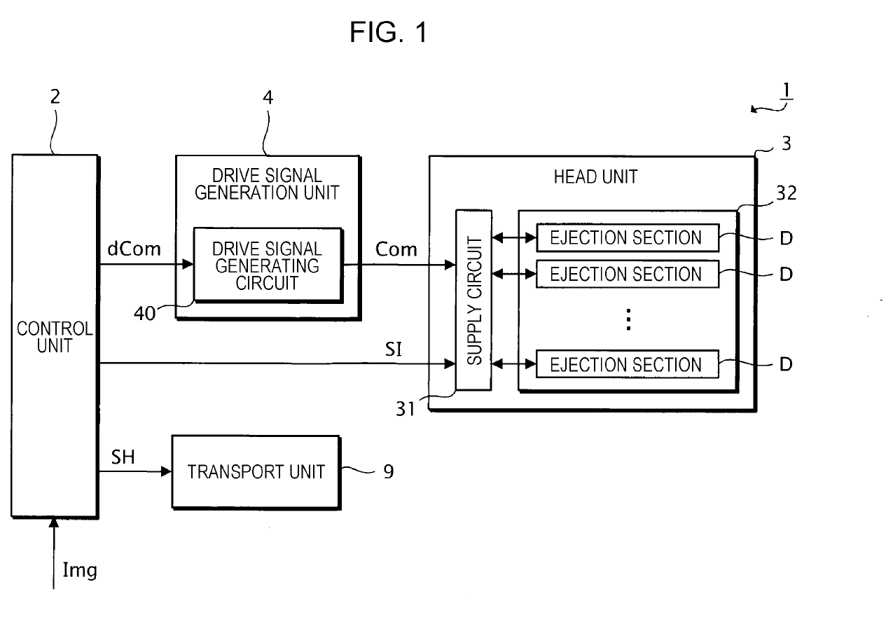

An example of a configuration of the ink jet printer 1 according to the present embodiment will be described with reference to FIGS. 1 to 3.

FIG. 1 is a functional block diagram illustrating the example of the configuration of the ink jet printer 1.

As illustrated in FIG. 1, print data Img indicating an image to be formed by the ink jet printer 1 is supplied to the ink jet printer 1 from a host computer such as a personal computer or a digital camera. The ink jet printer 1 executes a printing process of forming, on the recording sheet PP, the image indicated by the print data Img supplied from the host computer.

As illustrated in FIG. 1, the ink jet printer 1 includes a control unit 2 that controls each section of the ink jet printer 1, a head unit 3 including an ejection section D that ejects ink onto the recording sheet PP, a drive signal generation unit 4 including a drive signal generating circuit 40 that generates a drive signal Com for driving the ejection section D, and a transport unit 9 that transports the head unit 3 and the recording sheet PP.

In the present embodiment, the ink jet printer 1 is an example of a "liquid ejecting apparatus", the ink is an example of "liquid", and the drive signal generating circuit 40 is an example of a "drive circuit".

In the present embodiment, it is assumed that the ink jet printer 1 includes one or a plurality of head units 3. Specifically, in the present embodiment, as an example, it is assumed that the ink jet printer 1 includes four head units 3. In addition, hereinafter, for convenience of description, as illustrated in FIG. 1, the following description may focus on one head unit 3 among the four head units 3.

In the present embodiment, as an example, it is assumed that the ink jet printer 1 includes one or a plurality of drive signal generation units 4 corresponding to one head unit 3. Specifically, in the present embodiment, it is assumed that the ink jet printer 1 includes one drive signal generation unit 4 corresponding to one head unit 3. That is, in the present embodiment, it is assumed that the ink jet printer 1 includes four drive signal generation units 4 corresponding to the four head units 3. However, the present disclosure is not limited to this aspect. The ink jet printer 1 may include two drive signal generation units 4 corresponding to one head unit 3, or may include three or more drive signal generation units 4 corresponding to one head unit 3. For convenience of description, as illustrated in FIG. 1, the following description may focus on one drive signal generation unit 4 among the four drive signal generation units 4.

The control unit 2 includes a control circuit (not illustrated) and a storage circuit (not illustrated).

The storage circuit includes a volatile memory such as a random-access memory (RAM) and a nonvolatile memory such as a read-only memory (ROM), an electrically erasable programmable read-only memory (EEPROM), or a programmable ROM (PROM), and stores various types of information such as a control program of the ink jet printer 1.

The control circuit includes one or a plurality of central processing units (CPUs). However, the control circuit may include a programmable logic device such as a field-programmable gate array (FPGA) instead of the one or plurality of CPUs or in addition to the one or plurality of CPUs. The control circuit executes the control program of the ink jet printer 1 stored in the storage circuit, and controls each section of the ink jet printer 1 by operating in accordance with the control program. Specifically, the control circuit generates signals for controlling the operation of each section of the ink jet printer 1. The signals are a specifying signal SI, a waveform specifying signal dCom, a transport control signal SH, and the like.

The waveform specifying signal dCom is a digital signal for defining a waveform of the drive signal Com. The drive signal Com is an analog signal for driving the ejection section D. The specifying signal SI is a digital signal specifying the type of operation of the ejection section D. Specifically, the specifying signal SI specifies whether or not the drive signal Com is supplied to the ejection section D, and thus specifies the type of operation of the ejection section D, for example, specifies whether ink is to be ejected from the ejection section D. The transport control signal SH is a signal for controlling the transport unit 9.

When the printing process is executed, the control unit 2 generates, based on the print data Img, a signal for controlling the head unit 3, such as the specifying signal SI. In addition, when the printing process is executed, the control unit 2 generates a signal for controlling the drive signal generation unit 4, such as the waveform specifying signal dCom. In addition, when the printing process is executed, the control unit 2 generates a signal for controlling the transport unit 9, such as the transport control signal SH. Accordingly, in the printing process, the control unit 2 controls each section of the ink jet printer 1 so as to form the image corresponding to the print data Img on the recording sheet PP by adjusting whether ink is ejected from the ejection section D, the timing of ejecting the ink, and the like while controlling the transport unit 9 so as to move the head unit 3 and the recording sheet PP.

As illustrated in FIG. 1, the head unit 3 includes a supply circuit 31 and a head section 32.

The head section 32 includes M ejection sections D. In this case, the value M is a natural number satisfying "M ≥ 1". In the following description, the m-th ejection section D among the M ejection sections D included in the head section 32 may be referred to as an ejection section D[m]. In this case, the variable m is a natural number satisfying "1 ≤ m ≤ M". In the following description, in a case where a component, signal, or the like of the ink jet printer 1 corresponds to the ejection section D[m] among the M ejection sections D, a subscript [m] may be added to a reference sign for representing the component, signal, or the like.

The supply circuit 31 switches whether to supply a drive signal Com to the ejection section D[m] based on the specifying signal SI. In the following description, among drive signals Com, the drive signal Com supplied to the ejection section D[m] may be referred to as a supply drive signal Vin[m].

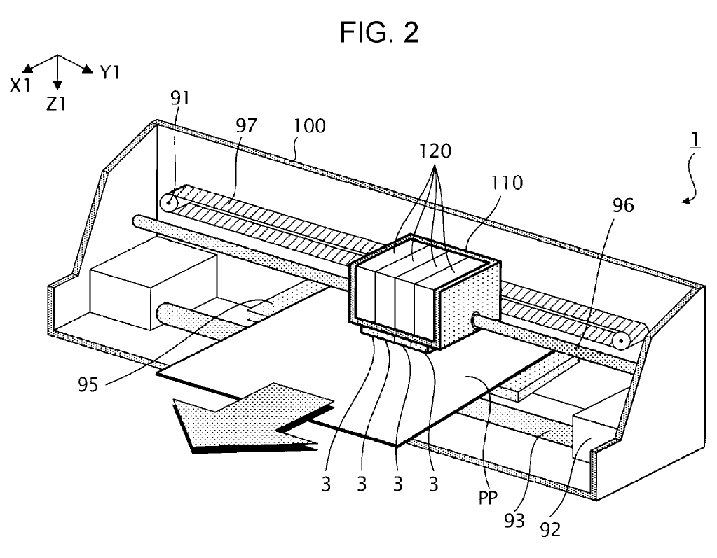

FIG. 2 is a perspective view illustrating an example of a schematic internal structure of the ink jet printer 1.

As illustrated in FIG. 2, in the present embodiment, it is assumed that the ink jet printer 1 is a serial printer. Specifically, when executing the printing process, the ink jet printer 1 forms the image corresponding to the print data Img on the recording sheet PP by ejecting ink from the head unit 3 while transporting the recording sheet PP in an X1 direction and moving the head unit 3 in a Y1 direction intersecting the X1 direction or in a Y2 direction opposite to the Y1 direction.

In the following description, the X1 direction and an X2 direction opposite to the X1 direction are collectively referred to as an "X-axis direction", the Y1 direction intersecting the X-axis direction, and the Y2 direction opposite to the Y1 direction are collectively referred to as a "Y-axis direction", and a Z1 direction intersecting the X-axis direction and the Y-axis direction, and a Z2 direction opposite to the Z1 direction are collectively referred to as a "Z-axis direction". In the present embodiment, as an example, it is assumed that the X-axis direction, the Y-axis direction, and the Z-axis direction are orthogonal to each other. However, the present disclosure is not limited to this aspect. The X-axis direction, the Y-axis direction, and the Z-axis direction may intersect each other. In the present embodiment, ink is ejected from each of the ejection sections D in the Z1 direction.

As illustrated in FIG. 2, the ink jet printer 1 according to the present embodiment includes a housing 100 and a carriage 110. The carriage 110 is capable of reciprocating in the Y-axis direction in the housing 100.

As illustrated in FIG. 2, in the present embodiment, it is assumed that four ink cartridges 120 corresponding one-to-one to ink of four colors of cyan, magenta, yellow, and black are mounted on the carriage 110. In addition, in the present embodiment, as described above, it is assumed that the four head units 3 corresponding one-to-one to the four ink cartridges 120 are mounted on the carriage 110. Each ejection section D[m] receives ink supplied from the ink cartridge 120 corresponding to the head unit 3 including the ejection section D[m]. As a result, each ejection section D[m] is filled with the supplied ink and can eject the ink filled in the ejection section D[m] from a nozzle N[m] disposed in the ejection section D[m]. The ink cartridges 120 may be disposed outside the carriage 110.

In addition, as described above, the ink jet printer 1 according to the present embodiment includes the transport unit 9. As illustrated in FIG. 2, the transport unit 9 includes a carriage transport motor 91, a medium transport motor 92, a medium transport mechanism 93, a platen 95, a carriage guide shaft 96, and a belt 97. The carriage transport motor 91 drives the belt 97 based on the transport control signal SH. The belt 97 transports the carriage 110 in the Y-axis direction based on the driving of the carriage transport motor 91. The carriage guide shaft 96 supports the carriage 110 such that the carriage 110 is capable of reciprocating in the Y-axis direction. The medium transport motor 92 drives the medium transport mechanism 93 based on the transport control signal SH. The medium transport mechanism 93 transports the recording sheet PP in the X1 direction by rotating based on the driving of the medium transport motor 92. The platen 95 is disposed in the Z1 direction with respect to the carriage 110, and supports the recording sheet PP transported by the medium transport mechanism 93. As described above, when the printing process is executed, the transport unit 9 causes the head unit 3 to reciprocate together with the carriage 110 in the Y-axis direction along the carriage guide shaft 96 by the carriage transport motor 91 and transports the recording sheet PP on the platen 95 in the X1 direction by the medium transport motor 92 so as to change the relative position of the recording sheet PP to the head unit 3, thereby making it possible for the ink to land on the entire recording sheet PP.

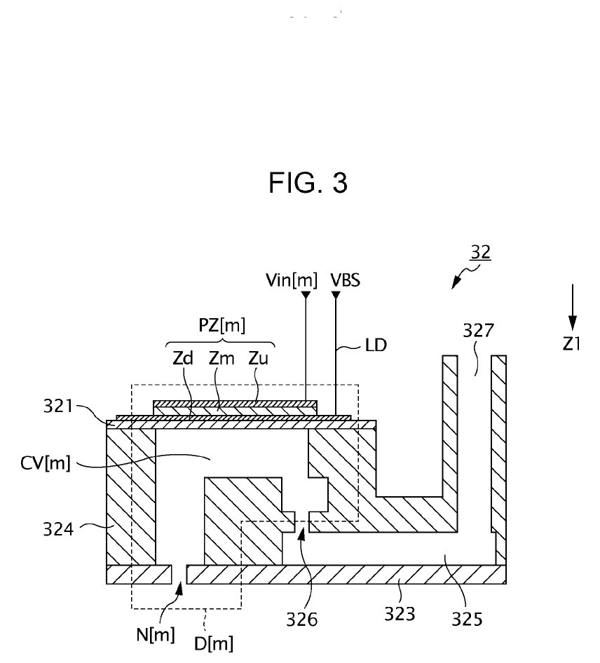

FIG. 3 is a schematic partial cross-sectional view of the head section 32, in which the head section 32 is taken so as to include the ejection section D[m].

As illustrated in FIG. 3, the ejection section D[m] includes a piezoelectric element PZ[m], a cavity CV[m] filled with ink, the nozzle N[m] communicating with the cavity CV[m], and a vibration plate 321. The ejection section D[m] ejects the ink in the cavity CV[m] from the nozzle N[m] when the piezoelectric element PZ[m] is driven by the supply drive signal Vin[m]. The cavity CV[m] is a space partitioned by a cavity plate 324, a nozzle plate 323 in which the nozzle N[m] is formed, and the vibration plate 321. The cavity CV[m] communicates with a reservoir 325 via an ink supply port 326. The reservoir 325 communicates with the ink cartridge 120 corresponding to the ejection section D[m] via an ink intake port 327. The piezoelectric element PZ[m] includes an upper electrode Zu[m], a lower electrode Zd[m], and a piezoelectric body Zm[m] disposed between the upper electrode Zu[m] and the lower electrode Zd[m]. The lower electrode Zd[m] is electrically coupled to a power supply line LD set to a predetermined electrical potential VBS. When the supply drive signal Vin[m] is supplied to the upper electrode Zu[m] and a voltage is applied between the upper electrode Zu[m] and the lower electrode Zd[m], the piezoelectric element PZ[m] is deformed in the Z1 direction and the Z2 direction in accordance with the applied voltage, and as a result, the piezoelectric element PZ[m] vibrates. The lower electrode Zd[m] is joined to the vibration plate 321. Therefore, when the piezoelectric element PZ[m] is driven by the supply drive signal Vin[m] and vibrates, the vibration plate 321 also vibrates. The volume of the cavity CV[m] and the pressure in the cavity CV[m] are changed by the vibration of the vibration plate 321, and the ink filled in the cavity CV[m] is ejected from the nozzle N[m].

### A.2. Configuration and Operation of Head Unit 3

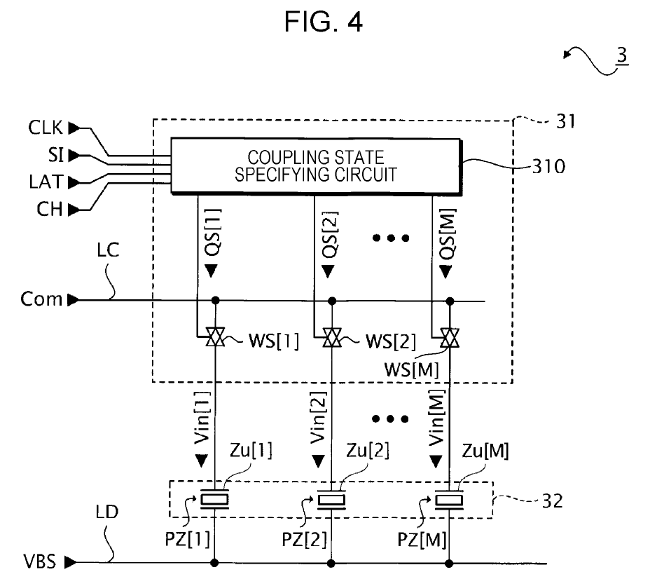

An example of a configuration and an operation of the head unit 3 will be described below with reference to FIGS. 4 to 6.

FIG. 4 is a block diagram illustrating an example of the configuration of the head unit 3.

As illustrated in FIG. 4, the head unit 3 includes the supply circuit 31 and the head section 32. The head unit 3 includes a wiring line LC through which the drive signal Com from the drive signal generation unit 4 is supplied.

As illustrated in FIG. 4, the supply circuit 31 includes M switches WS[1] to WS[M] corresponding one-to-one to the M ejection sections D[1] to D[M], and a coupling state specifying circuit 310 that specifies a coupling state of each of the switches WS[1] to WS[M].

The coupling state specifying circuit 310 generates a coupling state specifying signal QS[m] that specifies turning on or off of the switch WS[m], based on at least one of the specifying signal SI, the latch signal LAT, the change signal CH, and the clock signal CLK supplied from the control unit 2.

The switch WS[m] switches between conduction and non-conduction between the wiring line LC and the upper electrode Zu[m] of the piezoelectric element PZ[m] included in the ejection section D[m], based on the coupling state specifying signal QS[m]. In the present embodiment, the switch WS[m] is on when the coupling state specifying signal QS[m] is at a high level, and is off when the coupling state specifying signal QS[m] is at a low level. When the switch WS[m] is turned on, the drive signal Com supplied to the wiring line LC is supplied to the upper electrode Zu[m] of the ejection section D[m] as the supply drive signal Vin[m].

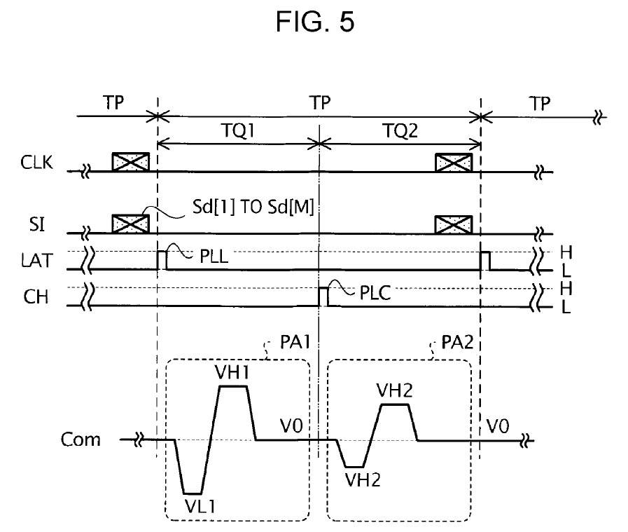

FIG. 5 is a timing chart illustrating an example of various signals supplied to the head unit 3, such as the drive signal Com.

As illustrated in FIG. 5, when the ink jet printer 1 executes the printing process, one or a plurality of unit periods TP are set as an operation period of the ink jet printer 1. In the present embodiment, the ink jet printer 1 can drive each ejection section D[m] for the printing process in each unit period TP.

As illustrated in FIG. 5, the control unit 2 outputs the latch signal LAT having a pulse PLL. Accordingly, the control unit 2 defines the unit period TP as a period from a rising edge of the pulse PLL to a rising edge of the next pulse PLL. The control unit 2 outputs the change signal CH having a pulse PLC in the unit period TP. The control unit 2 divides the unit period TP into a drive period TQ1 from the rising edge of the pulse PLL to a rising of the pulse PLC and a drive period TQ2 from the rising of the pulse PLC to the rising edge of the next pulse PLL.

As illustrated in FIG. 5, the specifying signal SI includes M individual specifying signals Sd[1] to Sd[M] corresponding one-to-one to the M ejection sections D[1] to D[M]. The individual specifying signal Sd[m] specifies a mode of driving the ejection section D[m] in each unit period TP when the ink jet printer 1 executes the printing process. The control unit 2 supplies the specifying signal SI including the M individual specifying signals Sd[1] to Sd[M] to the coupling state specifying circuit 310 in synchronization with the clock signal CLK prior to each unit period TP. The coupling state specifying circuit 310 generates the coupling state specifying signal QS[m] based on the individual specifying signal Sd[m] in the unit period TP.

In the present embodiment, it is assumed that the ejection section D[m] can form any one of a large dot of ink in an amount ξ1, a medium dot of ink in an amount ξ2 less than the amount ξ1, and a small dot of ink in an amount ξ3 less than the amount ξ2 in the unit period TP in which the printing process is executed.

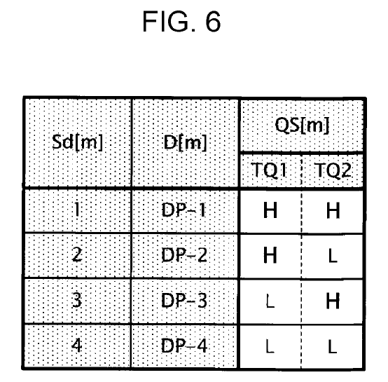

FIG. 6 is an explanatory diagram illustrating an example of the individual specifying signal Sd[m].

As illustrated in FIG. 6, in the present embodiment, the individual specifying signal Sd[m] can take any one of four values that are a value "1" that specifies the ejection section D[m] as a large dot forming ejection section DP-1, a value "2" that specifies the ejection section D[m] as a medium dot forming ejection section DP-2, a value "3" that specifies the ejection section D[m] as a small dot forming ejection section DP-3, and a value "4" that specifies the ejection section D[m] as a non-dot forming ejection section DP-4 in the unit period TP in which the printing process is executed.

The large dot forming ejection section DP-1 is an ejection section D that forms the large dot in the unit period TP. The medium dot forming ejection section DP-2 is an ejection section D that forms the medium dot in the unit period TP. The small dot forming ejection section DP-3 is an ejection section D that forms the small dot in the unit period TP. The non-dot forming ejection section DP-4 is an ejection section D that does not form a dot in the unit period TP.

Return to the description of FIG. 5.

As illustrated in FIG. 5, in the present embodiment, the drive signal Com has a waveform PA1 in the drive period TQ1 and a waveform PA2 in the drive period TQ2.

The waveform PA1 is a waveform in which an electrical potential returns from an electrical potential V0 to the electrical potential V0 through an electrical potential VL1 lower than the electrical potential V0 and an electrical potential VH1 higher than the electrical potential V0. When the supply drive signal Vin[m] having the waveform PA1 is to be supplied to the ejection section D[m], the waveform PA1 is determined such that ink in an amount corresponding to an amount φ1 is ejected from the ejection section D[m]. The waveform PA2 is a waveform in which the electrical potential returns from the electrical potential V0 to the electrical potential V0 through an electrical potential VL2 lower than the electrical potential V0 and an electrical potential VH2 higher than the electrical potential V0. When the supply drive signal Vin[m] having the waveform PA2 is to be supplied to the ejection section D[m], the waveform PA2 is determined such that ink in an amount corresponding to an amount φ2 is ejected from the ejection section D[m]. In the present embodiment, it is assumed that the amount ξ1 corresponds to the sum of the amount φ1 and the amount φ2, the amount ξ2 corresponds to the amount φ1, and the amount ξ3 corresponds to the amount φ2.

In the present embodiment, as an example, it is assumed that when the electrical potential of the supply drive signal Vin[m] supplied to the ejection section D[m] is high, the volume of the cavity CV[m] included in the ejection section D[m] is smaller than that in a case where the electrical potential of the supply drive signal Vin[m] supplied to the ejection section D[m] is low. Therefore, when the ejection section D[m] is driven by the supply drive signal Vin[m] having the waveform PA1 or the like, the electrical potential of the supply drive signal Vin[m] changes from a low electrical potential to a high electrical potential, and thus the ink in the ejection section D[m] is ejected from the nozzle N[m].

As illustrated in FIG. 6, in a case where the individual specifying signal Sd[m] indicates the value "1" specifying the ejection section D[m] as the large dot forming ejection section DP-1 in the unit period TP, the coupling state specifying circuit 310 sets the coupling state specifying signal QS[m] to a high level in the drive period TQ1 and the drive period TQ2. In this case, the switch WS[m] is on in the drive period TQ1 and the drive period TQ2. Therefore, the ejection section D[m] is driven by the supply drive signal Vin[m] having the waveform PA1 and the waveform PA2 in the unit period TP, and ejects the ink in the amount ξ1 corresponding to the large dot.

In a case where the individual specifying signal Sd[m] indicates the value "2" specifying the ejection section D[m] as the medium dot forming ejection section DP-2 in the unit period TP, the coupling state specifying circuit 310 sets the coupling state specifying signal QS[m] to a high level in the drive period TQ1. In this case, the switch WS[m] is on in the drive period TQ1. Therefore, the ejection section D[m] is driven by the supply drive signal Vin[m] having the waveform PA1 in the unit period TP, and ejects the ink in the amount ξ2 corresponding to the medium dot.

In a case where the individual specifying signal Sd[m] indicates the value "3" specifying the ejection section D[m] as the small dot forming ejection section DP-3 in the unit period TP, the coupling state specifying circuit 310 sets the coupling state specifying signal QS[m] to a high level in the drive period TQ2. In this case, the switch WS[m] is on in the drive period TQ2. Therefore, the ejection section D[m] is driven by the supply drive signal Vin[m] having the waveform PA2 in the unit period TP, and ejects the ink in the amount ξ3 corresponding to the small dot.

In a case where the individual specifying signal Sd[m] indicates the value "4" specifying the ejection section D[m] as the non-dot forming ejection section DP-4 in the unit period TP, the coupling state specifying circuit 310 sets the coupling state specifying signal QS[m] to a low level for the unit period TP. In this case, the switch WS[m] is off for the unit period TP. Therefore, the ejection section D[m] is not driven by the supply drive signal Vin[m] and does not eject the ink in the unit period TP.

### A.3. Configuration of Drive Signal Generating Circuit 40

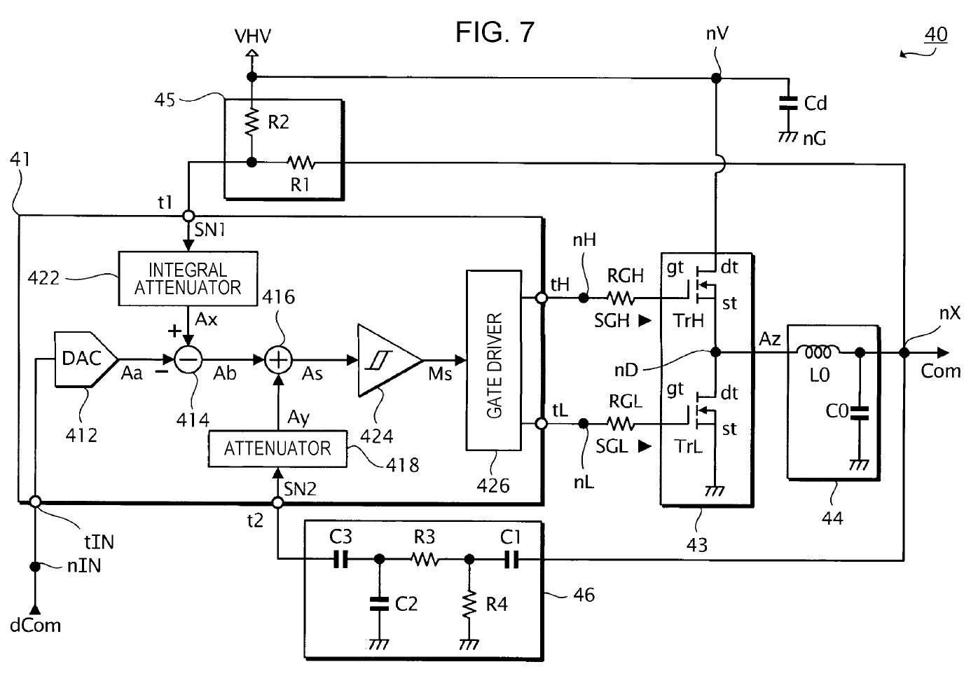

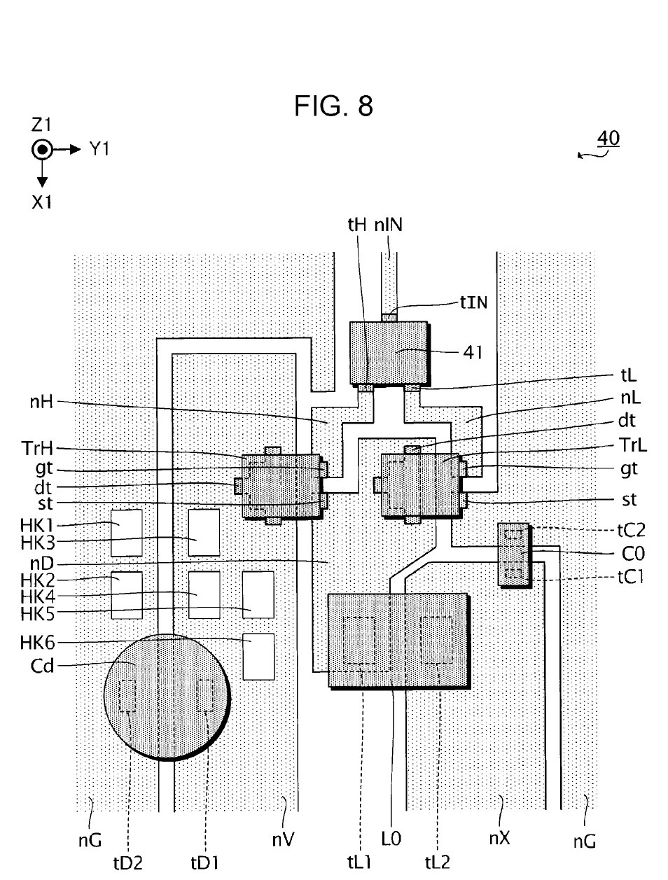

An example of a configuration of the drive signal generating circuit 40 disposed in the drive signal generation unit 4 will be described with reference to FIGS. 7 and 8.

FIG. 7 is a block diagram illustrating an example of a circuit configuration of the drive signal generating circuit 40.

As illustrated in FIG. 7, the drive signal generating circuit 40 includes an integrated circuit 41, an amplifier circuit 43, a smoothing circuit 44, a pull-up circuit 45, and a filter circuit 46, and is a class-D amplifier circuit that generates the drive signal Com based on the waveform specifying signal DCom.

The integrated circuit 41 is, for example, a large-scale integration (LSI) circuit, and generates a gate signal SGH and a gate signal SGL based on the waveform specifying signal dCom supplied to a terminal tIN through a node nIN. The integrated circuit 41 includes an analog conversion circuit 412, a subtractor 414, an adder 416, an attenuator 418, an integral attenuator 422, a comparator 424, and a gate driver 426.

The analog conversion circuit 412 is a digital-to-analog converter (DAC), and converts the digital waveform specifying signal dCom into an analog signal Aa. The voltage amplitude of the signal Aa is, for example, about 0 volts to 2 volts, and a signal obtained by amplifying the voltage of the signal Aa by about 20 times is the drive signal Com. That is, the signal Aa is a signal before the amplification of the drive signal Com.

The integral attenuator 422 outputs a signal Ax obtained by attenuating and integrating a signal SN1 input to a terminal t1 described later.

The subtractor 414 outputs a signal Ab indicating an electrical potential obtained by subtracting the electrical potential of the signal Aa from the electrical potential of the signal Ax.

The attenuator 418 outputs a signal Ay obtained by attenuating a high-frequency component of a signal SN2 input to a terminal t2 described later.

The adder 416 outputs a signal As indicating an electrical potential obtained by adding the electrical potential of the signal Ab to the electrical potential of the signal Ay.

The comparator 424 outputs a modulated signal Ms obtained by pulse-modulating the signal As. Specifically, the comparator 424 outputs the modulated signal Ms that becomes a high level when the voltage of the signal As increases and becomes greater than or equal to a threshold voltage Vth1, and that becomes a low level when the voltage of the signal As decreases and becomes less than a threshold voltage Vth2. The threshold voltage Vth1 and the threshold voltage Vth2 are set to have a relationship of "Vth1 > Vth2".

Note that a power supply voltage of a circuit from the analog conversion circuit 412 to the comparator 424 is a low voltage such as 3.3 volts. Meanwhile, the drive signal Com has a large amplitude, and may exceed 40 volts, for example. Therefore, the integral attenuator 422 attenuates the signal SN1 having an amplitude corresponding to the drive signal Com, and matches an amplitude range of the signal Ax with an amplitude range of a signal in the circuit from the analog conversion circuit 412 to the comparator 424.

In the present embodiment, the digital signal is described as an example of the waveform specifying signal dCom. However, the waveform specifying signal dCom may be any signal that defines a target value for generating the drive signal Com, and for example, the analog signal Aa may be the waveform specifying signal dCom. In a case where the signal Aa is the waveform specifying signal dCom, the integrated circuit 41 may not include the analog conversion circuit 412.

The gate driver 426 outputs the gate signal SGH obtained by converting the modulated signal Ms into a specific amplitude to a node nH through a terminal tH. The gate driver 426 outputs the gate signal SGL obtained by converting a signal obtained by inverting the logic level of the modulated signal Ms into a specific amplitude to a node nL through a terminal tL.

The amplifier circuit 43 includes, for example, a transistor TrH and a transistor TrL, and generates an amplified signal Az obtained by amplifying the modulated signal Ms, based on the gate signal SGH and the gate signal SGL output from the integrated circuit 41. In the present embodiment, as an example, it is assumed that the transistor TrH and the transistor TrL are field-effect transistors. More specifically, in the present embodiment, it is assumed that N-channel type metal-oxide-semiconductor field-effect transistors (MOSFETs) are used as the transistor TrH and the transistor TrL.

The gate signal SGH output from the gate driver 426 to the terminal tH is input to a gate electrode gt of the transistor TrH through the node nH and a resistor RGH. The gate signal SGL output from the gate driver 426 to the terminal tL is input to a gate electrode gt of the transistor TrL through the node nL and a resistor RGL. The logic level of the gate signal SGH and the logic level of the gate signal SGL are mutually exclusive. In this case, "being mutually exclusive" means that the signal level of the gate signal SGH supplied to the gate electrode gt of the transistor TrH and the signal level of the gate signal SGL supplied to the gate electrode gt of the transistor TrL are not a high level at the same time, in other words, the transistor TrH and the transistor TrL are not on at the same time. The transistor TrH is on when the electrical potential of the gate electrode gt of the transistor TrH is at a high level, and is off when the electrical potential of the gate electrode gt of the transistor TrH is at a low level. The transistor TrL is on when the electrical potential of the gate electrode gt of the transistor TrL is at a high level, and is off when the electrical potential of the gate electrode gt of the transistor TrL is at a low level.

A drain electrode dt of the transistor TrH is electrically coupled to a node nV set to a power supply electrical potential VHV on the high electrical potential side, and a source electrode st of the transistor TrH is electrically coupled to a node nD. A source electrode st of the transistor TrL is electrically coupled to a node nG set to the ground electrical potential, and a drain electrode dt of the transistor TrL is electrically coupled to the node nD. Note that the source electrode of the transistor TrL may be electrically coupled to the power supply line LD set to the electrical potential VBS.

As described above, the transistor TrH is on when the gate signal SGH supplied to the gate electrode gt of the transistor TrH is at a high level, and is off when the gate signal SGH supplied to the gate electrode gt of the transistor TrH is at a low level. The transistor TrL is on when the gate signal SGL supplied to the gate electrode gt of the transistor TrL is at a high level, and is off when the gate signal SGL supplied to the gate electrode gt of the transistor TrL is at a low level. Therefore, the amplified signal Az obtained by amplifying the modulated signal Ms is output to the node nD electrically connecting the source electrode st of the transistor TrH and the drain electrode dt of the transistor TrL.

An electrolytic capacitor Cd is coupled to the node nV to which the power supply electrical potential VHV is supplied. The electrolytic capacitor Cd has one end (terminal tD1) electrically coupled to the node nV, and the other end (terminal tD2) electrically coupled to the node nG set to the ground electrical potential. In the present embodiment, the electrolytic capacitor Cd is, for example, a large-capacity aluminum electrolytic capacitor, and suppresses a fluctuation in the electrical potential at the node nV to stabilize the power supply electrical potential VHV. The terminals tD1 and tD2 will be described later with reference to FIG. 8.

The smoothing circuit 44 is a low pass filter (LPF), and smooths the amplified signal Az to generate the drive signal Com. The smoothing circuit 44 includes an inductor L0 and a capacitor C0. The inductor L0 (an example of a "coil") has one end (terminal tL1) electrically coupled to the node nD, and the other end (terminal tL2) electrically coupled to a node nX. The capacitor C0 has one end (terminal tC1) electrically coupled to the node nX, and the other end (terminal tC2) electrically coupled to the node nG set to the ground electrical potential. The terminals tL1 and tL2 and the terminals tC1 and tC2 will be described later with reference to FIG. 8.

The pull-up circuit 45 feeds back, to the terminal t1, the signal SN1 obtained by pulling up the drive signal Com output to the node nX. The pull-up circuit 45 includes a resistor R1 having one end electrically coupled to the node nX and the other end electrically coupled to the terminal t1, and a resistor R2 having one end electrically coupled to the terminal t1 and the other end electrically coupled to the node nV set to the power supply electrical potential VHV.

The filter circuit 46 is a band pass filter (BPF), and feeds back, to the terminal t2, the signal SN2 obtained by removing a direct-current component from a frequency component included in the drive signal Com and having a frequency in a predetermined band. The filter circuit 46 includes a resistor R3, a capacitor C1, a resistor R4, a capacitor C2, and a capacitor C3. The capacitor C1 has one end electrically coupled to the node nX, and the other end electrically coupled to one end of the resistor R3. The resistor R4 has one end electrically coupled to the one end of the resistor R3, and the other end electrically coupled to the node nG set to the ground electrical potential. The capacitor C2 has one end electrically coupled to the other end of the resistor R3, and the other end electrically coupled to the node nG set to the ground electrical potential. The capacitor C3 has one end electrically coupled to the other end of the resistor R3, and the other end electrically coupled to the terminal t2. Among these, the capacitor C1 and the resistor R4 function as a high pass filter (HPF) that passes a high-frequency component included in the drive signal Com and having a frequency higher than or equal to a cut-off frequency of the HPF. The resistor R3 and the capacitor C2 function as a low-pass filter (LPF) that passes a low-frequency component included in the drive signal Com and having a frequency lower than or equal to a cutoff frequency of the LPF. In the present embodiment, in the filter circuit 46, the cutoff frequency of the HPF is set to be lower than the cutoff frequency of the LPF. Therefore, the filter circuit 46 passes a frequency component included in the drive signal Com and having a frequency that is in the predetermined band and higher than or equal to the cutoff frequency of the HPF and lower than or equal to the cutoff frequency of the LPF. In addition, since the filter circuit 46 includes the capacitor C3, the filter circuit 46 feeds back, to the terminal t2, a signal obtained by removing a direct-current component from a signal included in the drive signal Com, having passed through the HPF and the LPF, and having a frequency component in the predetermined band.

In this way, the drive signal generating circuit 40 generates the drive signal Com by smoothing the amplified signal Az at the node nD by the smoothing circuit 44. The drive signal Com is integrated and attenuated by the integral attenuator 422, and then fed back to the subtractor 414. Therefore, the drive signal generating circuit 40 self-oscillates at a frequency determined by a delay in the smoothing circuit 44, a delay in the integral attenuator 422, and a transfer function for the feedback. However, since the amount of a delay in a feedback path extending through the terminal t1 is large, it is not possible to increase the frequency of the self-oscillation only by the feedback through the terminal t1 to the extent that the accuracy of the waveform of the drive signal Com can be sufficiently secured. On the other hand, in the present embodiment, since a path for feeding back a high-frequency component of the drive signal Com through the terminal t2 is disposed separately from the path extending through the terminal t1, it is possible to reduce a delay in the feedback in the entire drive signal generating circuit 40. That is, in the present embodiment, the frequency of the signal As obtained by adding the signal Ay, which is the high-frequency component of the drive signal Com, to the signal Ab can be increased, as compared to a case where the path extending through the terminal t2 is not present, and thus it is possible to sufficiently secure the accuracy of the drive signal Com.

The transistor TrH, the transistor TrL, and the inductor L0 are examples of an "electronic component" that generates heat at the time of the generation of the drive signal Com by the drive signal generating circuit 40.

FIG. 8 is a plan view illustrating an example of a wiring pattern of the drive signal generating circuit 40 when a drive circuit substrate 400 on which the drive signal generating circuit 40 is disposed is viewed in plan view. FIG. 8 does not illustrate some of electronic components of the drive signal generating circuit 40. A case where the drive circuit substrate 400 is disposed on a flat surface whose normal direction is the Z1 direction will be described as an example with reference to FIG. 8, but the present disclosure is not limited to this aspect. The normal direction of the drive circuit substrate 400 may be any direction. The drive circuit substrate 400 is an example of a "circuit substrate".

As illustrated in FIG. 8, the terminal tIN of the integrated circuit 41 is coupled to the node nIN. The terminal tH of the integrated circuit 41 is electrically coupled to the gate electrode gt of the transistor TrH via the node nH, and the terminal tL of the integrated circuit 41 is electrically coupled to the gate electrode gt of the transistor TrL via the node nL.

The source electrode st of the transistor TrL is electrically coupled to the node nG. The drain electrode dt of the transistor TrL is electrically coupled to the source electrode st of the transistor TrH and the terminal tL1 of the inductor L0 via the node nD. The terminal tL2 of the inductor L0 is electrically coupled to the terminal tC1 of the capacitor C0 via the node nX. The terminal tC2 of the capacitor C0 is electrically coupled to the node nG.

The drain electrode dt of the transistor TrH is electrically coupled to the terminal tD1 of the electrolytic capacitor Cd via the node nV. The terminal tD2 of the electrolytic capacitor Cd is electrically coupled to the node nG.

In the present embodiment, when the drive circuit substrate 400 is viewed in the Z1 direction, a non-coating region HK that is on the wiring pattern of the drive signal generating circuit 40 and is not coated with a resist and in which the electronic components of the drive signal generating circuit 40 are not disposed and the wiring pattern is exposed is disposed separately from a region that is on the wiring pattern of the drive signal generating circuit 40 and is coated with the resist. For example, in the present embodiment, it is assumed that non-coating regions HK1 and HK2 in which the node nG is exposed and non-coating regions HK3, HK4, HK5, and HK6 in which the node nV is exposed are disposed.

### A.4. Configuration of Drive Signal Generation Unit 4

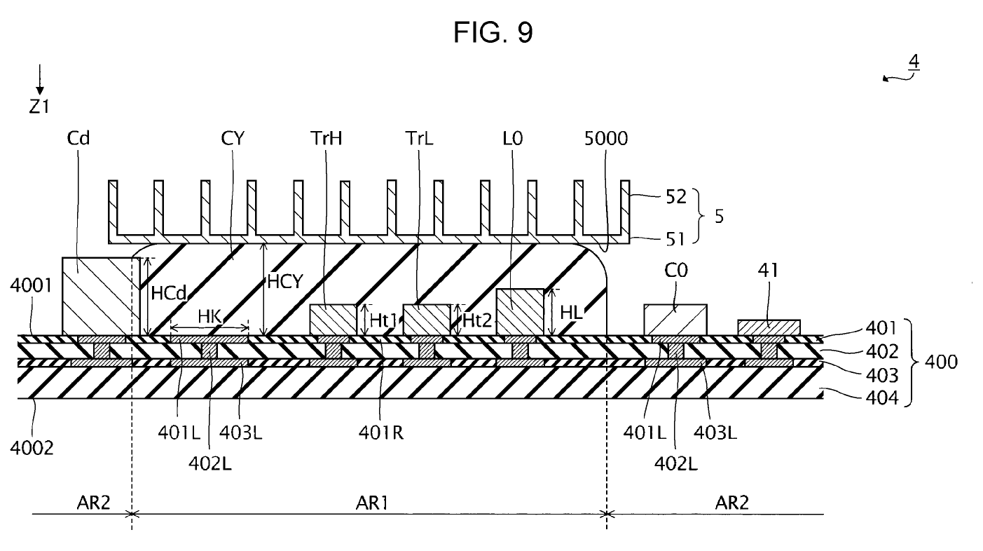

A configuration of the drive signal generation unit 4 will be described below with reference to FIGS. 9 to 11.

FIG. 9 is a cross-sectional view illustrating an example of the drive signal generation unit 4. Specifically, FIG. 9 is a cross-sectional view of the drive signal generation unit 4 taken along a cross section including a polygonal line extending through the integrated circuit 41, the transistor TrH, the transistor TrL, the inductor L0, the capacitor C0, and the electrolytic capacitor Cd when the drive circuit substrate 400 is viewed in the Z1 direction.

As illustrated in FIG. 9, the drive signal generation unit 4 includes the drive circuit substrate 400, the drive signal generating circuit 40, thermally conductive clay CY, and a heatsink 5.

The drive circuit substrate 400 includes an upper substrate surface 4001 on which the drive signal generating circuit 40 is disposed, and a lower substrate surface 4002 opposite to the upper substrate surface 4001. In the present embodiment, it is assumed that the drive circuit substrate 400 is a multilayer substrate. Specifically, in the present embodiment, the drive circuit substrate 400 includes a plurality of layers including a surface layer 401, an insulating layer 402, a wiring layer 403, and a protective layer 404 that are disposed between the upper substrate surface 4001 and the lower substrate surface 4002.

The surface layer 401 includes the upper substrate surface 4001, and a wiring line 401L is disposed in the surface layer 401. The wiring line 401L is made of a conductive material. A portion of the surface layer 401 other than the wiring line 401L is coated with an insulating resist member 401R. In addition, as described above, the surface layer 401 includes the non-coating region HK. In the non-coating region HK, the electronic components such as the transistor TrH are not disposed, the wiring line 401L is exposed, and the resist member 401R is not disposed.

A wiring line 402L is disposed in the insulating layer 402. The insulating layer 402 is disposed between the surface layer 401 and the lower substrate surface 4002. The wiring line 402L is made of a conductive material. A portion of the insulating layer 402 other than the wiring line 402L is made of an insulating material.

A wiring line 403L is disposed in the wiring layer 403. The wiring layer 403 is disposed between the insulating layer 402 and the lower substrate surface 4002. The wiring line 403L is made of a conductive material. A portion of the wiring layer 403 other than the wiring line 403L is made of an insulating material.

The protective layer 404 includes the lower substrate surface 4002 and is made of an insulating material.

In the present embodiment, it is assumed that the wiring pattern of the drive signal generating circuit 40 described with reference to FIG. 8 includes the wiring line 401L, the wiring line 402L, and the wiring line 403L.

The thermally conductive clay CY (an example of a "thermally conductive member") is a clay-like member having an electrical insulation property and thermal conductivity, and is disposed on the upper substrate surface 4001 so as to cover at least a portion of the drive signal generating circuit 40. Specifically, in the present embodiment, the thermally conductive clay CY is disposed so as to cover a portion of the electrolytic capacitor Cd, the transistor TrH, the transistor TrL, and the inductor L0. Note that the present disclosure is not limited to this aspect. The thermally conductive clay CY may be disposed so as to cover an electronic component other than the transistor TrH, the transistor TrL, the inductor C0, and the electrolytic capacitor Cd. In this case, the electronic component is the capacitor L0, the integrated circuit 41, or the like. In addition, the thermally conductive clay CY may be disposed so as not to cover one or more electronic components among the transistor TrH, the transistor TrL, and the inductor L0.

In the present embodiment, it is assumed that the height HCY of the thermally conductive clay CY in the Z-axis direction is greater than the height HCd of the electrolytic capacitor Cd in the Z-axis direction, the height Ht1 of the transistor TrH in the Z-axis direction, the height Ht2 of the transistor TrL in the Z-axis direction, and the height HL of the inductor L0 in the Z-axis direction. In addition, in the present embodiment, a case where the height Ht1 and the height Ht2 are equal, the height HCd is greater than the height Ht1, and the height HL is greater than the height Ht1 is assumed as an example.

In addition, hereinafter, when the drive circuit substrate 400 is viewed in plan view in the Z1 direction, a region that is included in the drive circuit substrate 400 and covered with the thermally conductive clay CY is referred to as a clay-disposed region AR1, and a region that is included in the drive circuit substrate 400 and is not covered with the thermally conductive clay CY is referred to as a clay-free region AR2. As described above, in the present embodiment, the thermally conductive clay CY is disposed to cover the non-coating region HK. That is, in the present embodiment, the clay-disposed region AR1 includes the non-coating region HK.

The heatsink 5 is made of a thermally conductive member such as aluminum, and includes a flat plate portion 51 and a heat dissipation portion 52. The flat plate portion 51 is a flat plate-shaped component extending on the XY plane, and has a planar portion 5000. The planar portion 5000 is a flat surface whose normal direction is the Z1 direction, and is in contact with the thermally conductive clay CY. The heat dissipation portion 52 has a plurality of fins and dissipates heat transferred from the flat plate portion 51.

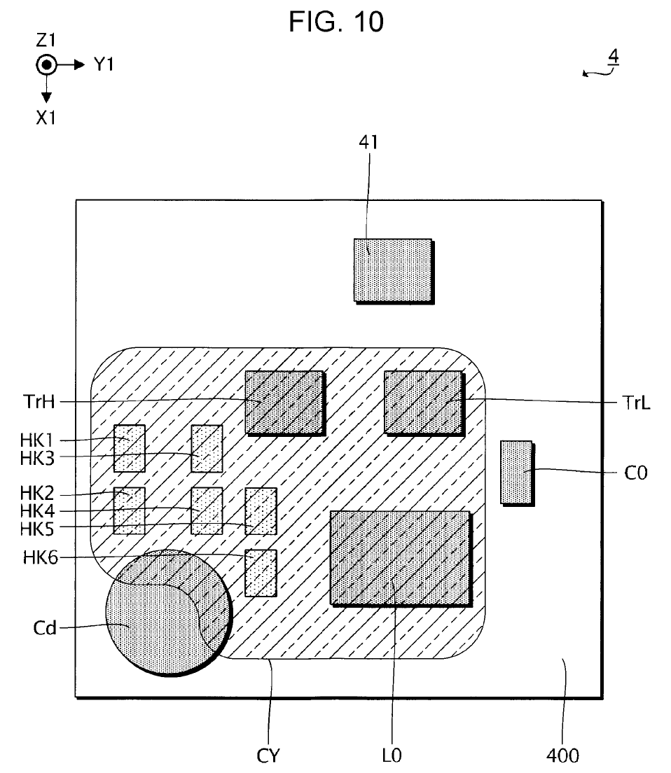

FIG. 10 is a plan view of the drive signal generation unit 4 as viewed in the Z1 direction.

As illustrated in FIG. 10, in the present embodiment, when the drive signal generation unit 4 is viewed in plan view in the Z1 direction, the thermally conductive clay CY is disposed so as to cover the portion of the electrolytic capacitor Cd, the transistor TrH, the transistor TrL, and the inductor L0. In the present embodiment, it is assumed that the thermally conductive clay CY is disposed so as to cover only the portion of the electrolytic capacitor Cd and not to cover the other portion of the electrolytic capacitor Cd. The thermally conductive clay CY is disposed so as to cover the non-coating regions HK1 and HK2 and the non-coating regions HK3, HK4, HK5, and HK6.

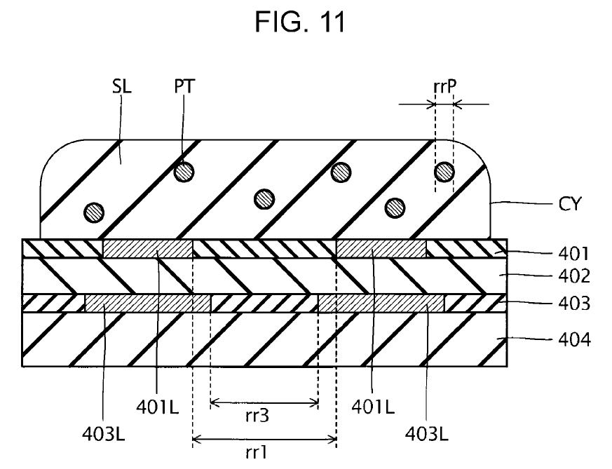

FIG. 11 is a schematic diagram for explaining an outline of the thermally conductive clay CY.

As illustrated in FIG. 11, the thermally conductive clay CY includes, for example, silicone clay SL and a thermally conductive particle PT. The silicone clay SL is a clay-like substance made of silicone, and serves as a base material of the thermally conductive clay CY. The thermally conductive particle PT is made of a substance having high thermal conductivity, such as diamond, gold, silver, or copper, and is dispersed in the silicone clay SL.

In this case, the diameter rrP of the thermally conductive particle PT is set to be sufficiently less than the minimum interval rr1 between two adjacent wiring lines 401L disposed in the surface layer 401 and the minimum interval rr3 between two adjacent wiring lines 403L disposed in the wiring layer 403. Therefore, in the present embodiment, even in a case where the thermally conductive clay CY is in contact with the two adjacent wiring lines 401L or the two adjacent wiring lines 403L, it is possible to prevent the two wiring lines from being electrically coupled by the thermally conductive clay CY, and it is possible to secure the electrical insulation of the thermally conductive clay CY in the drive signal generation unit 4. In the present embodiment, since the thermally conductive clay CY contains the thermally conductive particle PT, the thermal conductivity of the thermally conductive clay CY can be increased, as compared to an aspect in which the thermally conductive clay CY does not contain the thermally conductive particle PT.

### A.5. Summary of Embodiments

As described above, according to the present embodiment, the thermally conductive clay CY that is a clay-like member is in contact with the transistor TrH, the transistor TrL, and the inductor L0. Therefore, according to the present embodiment, for example, even in a case where the heights of the transistor TrH, the transistor TrL, and the inductor L0 are different, the thermally conductive clay CY can be in close contact with the transistor TrH, the transistor TrL, and the inductor L0, and heat generated from the drive signal generating circuit 40 can be efficiently dissipated through the thermally conductive clay CY.

In addition, according to the present embodiment, the thermally conductive clay CY is in contact with the transistor TrH, the transistor TrL, and the inductor L0, and the thermally conductive clay CY is in contact with the planar portion 5000 of the heatsink 5. Therefore, according to the present embodiment, for example, as compared to an aspect in which a heatsink including a plurality of protrusions having heights corresponding to the heights of the plurality of electronic components constituting the drive signal generating circuit 40 is used, the configuration of the heatsink 5 can be simplified, and the load for manufacturing a configuration for cooling the drive signal generating circuit 40 can be reduced or the cost of manufacturing the configuration for cooling the drive signal generating circuit 40 can be reduced.

In addition, according to the present embodiment, the thermally conductive clay CY is in contact with the transistor TrH, the transistor TrL, and the inductor L0, and the thermally conductive clay CY is in contact with the electrolytic capacitor Cd. In the present embodiment, the thermally conductive clay CY is a large-capacity aluminum electrolytic capacitor, and has a large surface area and high thermal conductivity. Therefore, according to the present embodiment, for example, heat generated from the drive signal generating circuit 40 can be efficiently dissipated through the thermally conductive clay CY, as compared to an aspect in which the thermally conductive clay CY is not in contact with the electrolytic capacitor Cd.

In addition, according to the present embodiment, the thermally conductive clay CY is in contact with the transistor TrH, the transistor TrL, and the inductor L0, and the thermally conductive clay CY is in contact with the non-coating region HK. Therefore, according to the present embodiment, for example, heat generated from the drive signal generating circuit 40 can be efficiently dissipated through the thermally conductive clay CY, as compared to an aspect in which the thermally conductive clay CY is not in contact with the non-coating region HK.

### B. Modifications

Each embodiment described above can be modified in various manners. Specific modifications will be described below. Two or more aspects selected in any manner from the following examples can be appropriately combined with one another within a range in which the aspects are not inconsistent with one another. In the modifications described below, elements having the same effects and functions as those described in the embodiments will be given the reference signs used in the above description, and each detailed description thereof will be appropriately omitted.

### B.1. First Modification

In the above-described embodiments, the case where the thermally conductive clay CY is in contact with the non-coating region HK and the heatsink 5 has been described as an example, but the present disclosure is not limited to this aspect. For example, the thermally conductive clay CY may not be in contact with one or both of the non-coating region HK and the heatsink 5.

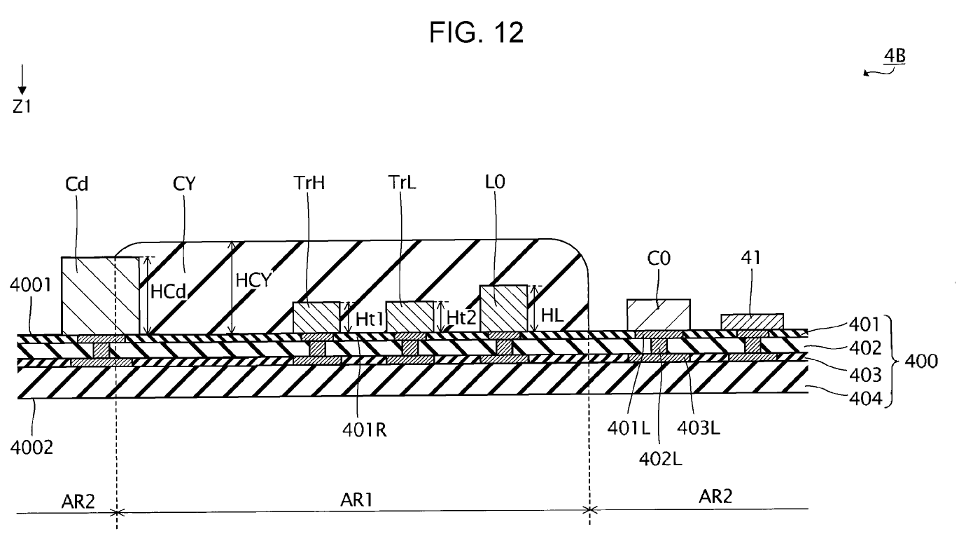

FIG. 12 is a cross-sectional view illustrating an example of a drive signal generation unit 4B according to the present modification.

As illustrated in FIG. 12, the drive signal generation unit 4B is different from the drive signal generation unit 4 according to the embodiment in that the drive signal generation unit 4B does not include the heatsink 5 and the non-coating region HK. In the present modification, the thermally conductive clay CY is disposed so as to cover a portion of the electrolytic capacitor Cd, the transistor TrH, the transistor TrL, and the inductor L0. However, in the present modification, the thermally conductive clay CY may be disposed so as to cover an electronic component other than the transistor TrH, the transistor TrL, the inductor C0, and the electrolytic capacitor Cd. In this case, the electronic component is the capacitor L0, the integrated circuit 41, or the like. In addition, in the present modification, the thermally conductive clay CY may be disposed so as not to cover one or more electronic components among the transistor TrH, the transistor TrL, and the inductor L0.

In the present modification, it is assumed that the height HCY of the thermally conductive clay CY in the Z-axis direction is greater than the height HCd of the electrolytic capacitor Cd in the Z-axis direction, the height Ht1 of the transistor TrH in the Z-axis direction, the height Ht2 of the transistor TrL in the Z-axis direction, and the height HL of the inductor L0 in the Z-axis direction. However, in the present modification, the height HCY of the thermally conductive clay CY in the Z-axis direction may be less than one or more or all of the height HCd, the height Ht1, the height Ht2, and the height HL.

As described above, according to the present modification, the thermally conductive clay CY is in contact with the transistor TrH, the transistor TrL, and the inductor L0, and the thermally conductive clay CY is in contact with the electrolytic capacitor Cd. Therefore, according to the present modification, for example, heat generated from the drive signal generating circuit 40 can be efficiently dissipated through the thermally conductive clay CY, as compared to an aspect in which the thermally conductive clay CY is not in contact with the electrolytic capacitor Cd.

### B.2. Second Modification

In the above-described embodiments, the case where the thermally conductive clay CY is in contact with the non-coating region HK and the electrolytic capacitor Cd has been described as an example, but the present disclosure is not limited to this aspect. For example, the thermally conductive clay CY may not be in contact with one or both of the non-coating region HK and the electrolytic capacitor Cd.

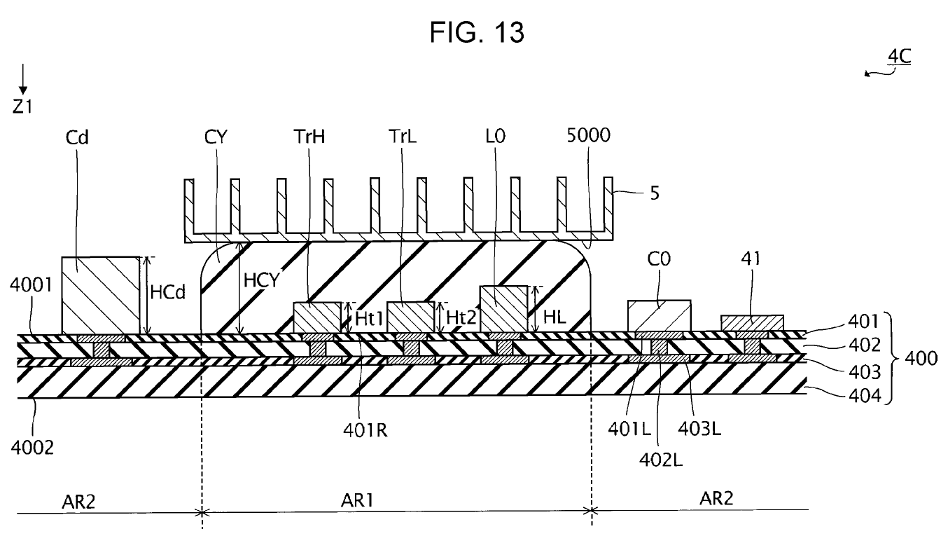

FIG. 13 is a cross-sectional view illustrating an example of a drive signal generation unit 4C according to the present modification.

As illustrated in FIG. 13, the drive signal generation unit 4C is different from the drive signal generation unit 4 according to the embodiment in that the drive signal generation unit 4C does not include the non-coating region HK and that the thermally conductive clay CY is not in contact with the electrolytic capacitor Cd. In the present modification, the thermally conductive clay CY is disposed so as to cover the transistor TrH, the transistor TrL, and the inductor L0 and is in contact with the planar portion 5000 of the heatsink 5. However, in the present modification, the thermally conductive clay CY may be disposed so as to cover an electronic component other than the transistor TrH, the transistor TrL, the inductor C0, and the electrolytic capacitor Cd. In this case, the electronic component is the capacitor L0, the integrated circuit 41, or the like. In addition, in the present modification, the thermally conductive clay CY may be disposed so as not to cover one or more electronic components among the transistor TrH, the transistor TrL, and the inductor L0.

In the present modification, it is assumed that the height HCY of the thermally conductive clay CY in the Z-axis direction is greater than the height HCd of the electrolytic capacitor Cd in the Z-axis direction, the height Ht1 of the transistor TrH in the Z-axis direction, the height Ht2 of the transistor TrL in the Z-axis direction, and the height HL of the inductor L0 in the Z-axis direction.

As described above, according to the present modification, the thermally conductive clay CY is in contact with the transistor TrH, the transistor TrL, and the inductor L0, and the thermally conductive clay CY is in contact with the planar portion 5000 of the heatsink 5. Therefore, according to the present modification, for example, it is possible to simplify the configuration of the heatsink 5, as compared to an aspect in which a heatsink including a plurality of protrusions having heights corresponding to the heights of the plurality of electronic components constituting the drive signal generating circuit 40 is used.

### B.3. Third Modification

In the above-described embodiments, the case where the thermally conductive clay CY is in contact with the electrolytic capacitor Cd and the heatsink 5 has been described as an example, but the present disclosure is not limited to this aspect. For example, the thermally conductive clay CY may not be in contact with one or both of the electrolytic capacitor Cd and the heatsink 5.

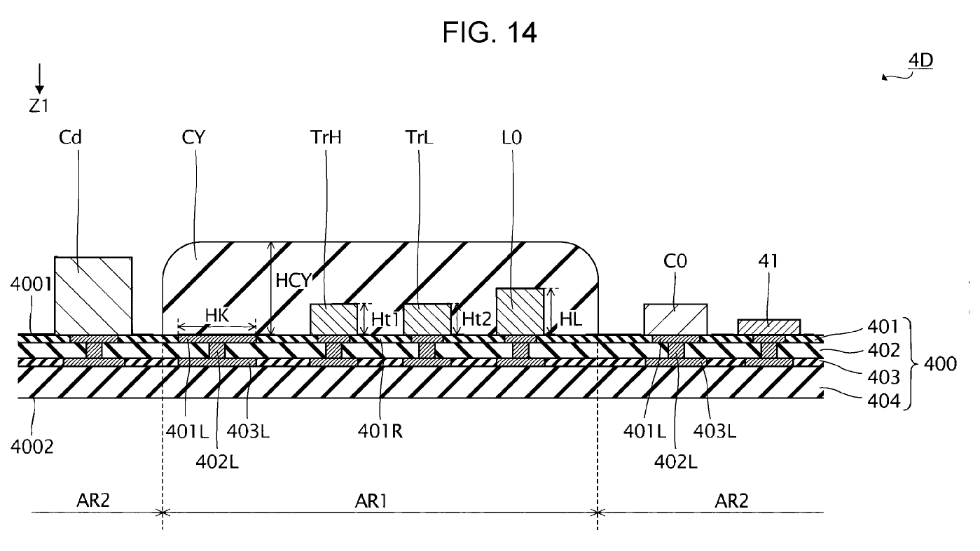

FIG. 14 is a cross-sectional view illustrating an example of a drive signal generation unit 4D according to the present modification.

As illustrated in FIG. 14, the drive signal generation unit 4D is different from the drive signal generation unit 4 according to the embodiment in that the drive signal generation unit 4D does not include the heatsink 5 and that the thermally conductive clay CY is not in contact with the electrolytic capacitor Cd. In the present modification, the thermally conductive clay CY is disposed so as to cover the non-coating region HK, the transistor TrH, the transistor TrL, and the inductor L0. However, in the present modification, the thermally conductive clay CY may be disposed so as to cover an electronic component other than the transistor TrH, the transistor TrL, the inductor C0, and the electrolytic capacitor Cd. In this case, the electronic component is the capacitor L0, the integrated circuit 41, or the like. In addition, in the present modification, the thermally conductive clay CY may be disposed so as not to cover one or more electronic components among the transistor TrH, the transistor TrL, and the inductor L0.

In the present modification, it is assumed that the height HCY of the thermally conductive clay CY in the Z-axis direction is greater than the height Ht1 of the transistor TrH in the Z-axis direction, the height Ht2 of the transistor TrL in the Z-axis direction, and the height HL of the inductor L0 in the Z-axis direction. However, in the present modification, the height HCY of the thermally conductive clay CY in the Z-axis direction may be less than one or more or all of the height Ht1, the height Ht2, and the height HL.

As described above, according to the present modification, the thermally conductive clay CY is in contact with the transistor TrH, the transistor TrL, and the inductor L0, and the thermally conductive clay CY is in contact with the non-coating region HK. Therefore, according to the present modification, for example, heat generated from the drive signal generating circuit 40 can be efficiently dissipated through the thermally conductive clay CY, as compared to an aspect in which the thermally conductive clay CY is not in contact with the non-coating region HK.

### B.4. Fourth Modification

In the above-described embodiments and the first to third modifications, the case where the drive signal generating circuit 40 is the class-D amplifier circuit has been described as an example, but the present disclosure is not limited to this aspect. The drive signal generating circuit 40 may be an amplifier circuit other than the class-D amplifier circuit. For example, the drive signal generating circuit 40 may be a class-AB amplifier circuit.

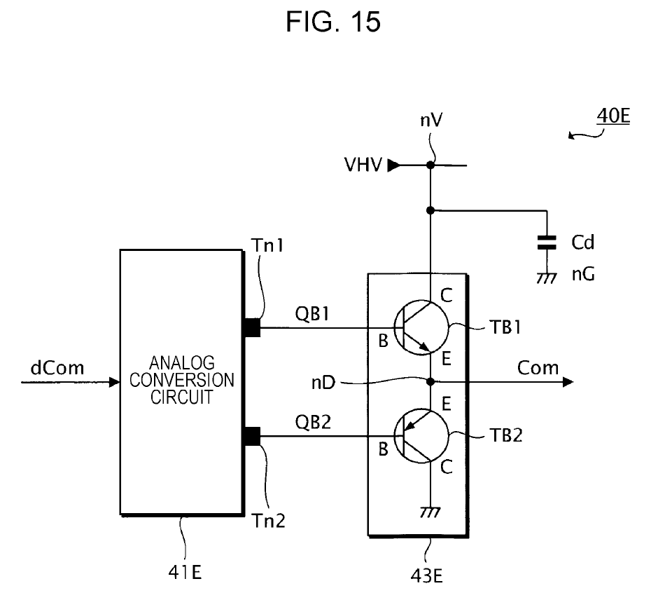

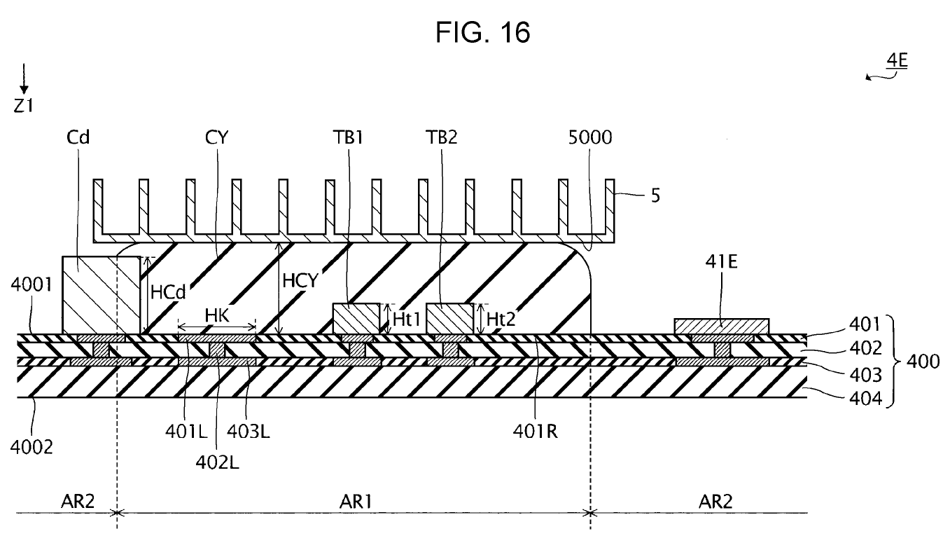

FIG. 15 is a block diagram illustrating an example of a circuit configuration of a drive signal generating circuit 40E according to the present modification. FIG. 16 is a cross-sectional view illustrating an example of a drive signal generation unit 4E according to the present modification. An ink jet printer according to the present modification is different from the ink jet printer 1 according to the embodiment in that the ink jet printer according to the present modification includes the drive signal generation unit 4E instead of the drive signal generation unit 4. In addition, the drive signal generation unit 4E according to the present modification is different from the drive signal generation unit 4 according to the embodiment in that the drive signal generation unit 4E includes the drive signal generating circuit 40E instead of the drive signal generating circuit 40.

As illustrated in FIG. 15, the drive signal generating circuit 40E includes an analog conversion circuit 41E, a pair 43E of transistors, and an electrolytic capacitor Cd, and generates a drive signal Com based on a waveform specifying signal dCom. Specifically, for example, the drive signal generating circuit 40E generates the drive signal Com by performing class AB amplification on an analog input signal obtained by converting the waveform specifying signal dCom.

The analog conversion circuit 41E outputs a waveform specifying signal QB including a base supply signal QB1 and a base supply signal QB2 based on the digital waveform specifying signal dCom. Specifically, the analog conversion circuit 41E converts the waveform specifying signal dCom into the analog input signal, and then generates the base supply signal QB1 and the base supply signal QB2. The base supply signal QB1 is an analog signal indicating an electrical potential based on the electrical potential of the input signal, and the base supply signal QB2 is an analog signal indicating an electrical potential that is based on the electrical potential of the input signal and lower than the electrical potential of the base supply signal QB1. The analog conversion circuit 41E outputs the base supply signal QB1 from an output terminal Tn1, and outputs the base supply signal QB2 from an output terminal Tn2.

The pair 43E of transistors is a so-called push-pull circuit including an NPN-type bipolar transistor TB1 and a PNP-type bipolar transistor TB2, and generates the drive signal Com based on the base supply signal QB1 and the base supply signal QB2.

The bipolar transistor TB1 has a base electrode (B) electrically coupled to the output terminal Tn1, and the base supply signal QB1 is supplied to the base electrode (B) of the bipolar transistor TB1 from the output terminal Tn1. The bipolar transistor TB1 has a collector electrode (C) electrically coupled to the node nV set to the power supply electrical potential VHV, and an emitter electrode (E) electrically coupled to the node nD for supplying the drive signal Com. For example, the bipolar transistor TB1 is turned on when the electrical potential of the base supply signal QB1 increases, and as a result, the bipolar transistor TB1 increases the electrical potential of the drive signal Com. In addition, for example, the bipolar transistor TB1 is turned off when the electrical potential of the base supply signal QB1 becomes constant and when the electrical potential of the base supply signal QB1 decreases.

The bipolar transistor TB2 has a base electrode (B) electrically coupled to the output terminal Tn2, and the base supply signal QB2 is supplied to the base electrode (B) of the bipolar transistor TB2 from the output terminal Tn2. In addition, the bipolar transistor TB2 has a collector electrode (C) electrically coupled to the node nG set to the ground electrical potential, and an emitter electrode (E) electrically coupled to the node nD for supplying the drive signal Com. For example, the bipolar transistor TB2 is turned on when the electrical potential of the base supply signal QB2 decreases, and as a result, the bipolar transistor TB2 decreases the electrical potential of the drive signal Com. For example, the bipolar transistor TB2 is turned off when the electrical potential of the base supply signal QB2 becomes constant and when the electrical potential of the base supply signal QB2 increases.

The electrolytic capacitor Cd is a capacitor for supplying a current to the pair 43E of transistors. Specifically, one of two electrodes of the electrolytic capacitor Cd is electrically coupled to the node nV set to the power supply electrical potential VHV and the collector electrode of the bipolar transistor TB1, and the other of the two electrodes of the electrolytic capacitor Cd is electrically coupled to the node nG set to the ground electrical potential.

FIG. 16 is a cross-sectional view illustrating an example of the drive signal generation unit 4E according to the present modification.

As illustrated in FIG. 16, the drive signal generation unit 4E is different from the drive signal generation unit 4 according to the embodiment in that the drive signal generation unit 4E includes the drive signal generating circuit 40E instead of the drive signal generating circuit 40. In the present modification, the thermally conductive clay CY is disposed so as to cover a portion of the electrolytic capacitor Cd, the non-coating region HK, the bipolar transistor TB1, and the bipolar transistor TB2. In the present modification, the thermally conductive clay CY is in contact with the planar portion 5000 of the heatsink 5. However, in the present modification, the thermally conductive clay CY may be disposed so as to cover an electronic component other than the bipolar transistor TB1, the bipolar transistor TB2, and the electrolytic capacitor Cd. In this case, the electronic component is the analog conversion circuit 41E or the like. In the present modification, the thermally conductive clay CY may be disposed so as not to cover one or more electronic components among the bipolar transistor TB1, the bipolar transistor TB2, and the electrolytic capacitor Cd.

In the present modification, it is assumed that the height HCY of the thermally conductive clay CY in the Z-axis direction is greater than the height Ht1 of the bipolar transistor TB1 in the Z-axis direction and the height Ht2 of the bipolar transistor TB2 in the Z-axis direction. In addition, in the modification example, the bipolar transistor TB1 and the bipolar transistor TB2 are examples of an "electronic component" that generates heat at the time of the generation of the drive signal Com by the drive signal generating circuit 40E.

As described above, according to the present modification, the thermally conductive clay CY is in contact with the bipolar transistor TB1 and the bipolar transistor TB2, and the thermally conductive clay CY is in contact with the portion of the electrolytic capacitor Cd, the heatsink 5, and the non-coating region HK. Therefore, according to the present modification, for example, heat generated from the drive signal generating circuit 40E can be efficiently dissipated through the thermally conductive clay CY, as compared to an aspect in which the thermally conductive clay CY is not disposed.

### B.5. Fifth Modification

In the above-described embodiments and the first to fourth modifications, the aspect in which the thermally conductive clay CY is individually disposed in each of the plurality of drive signal generation units 4 included in the ink jet printer 1 has been described as an example, but the present disclosure is not limited to this aspect. The thermally conductive clay CY may be disposed in common to the plurality of drive signal generation units 4 included in the ink jet printer 1.

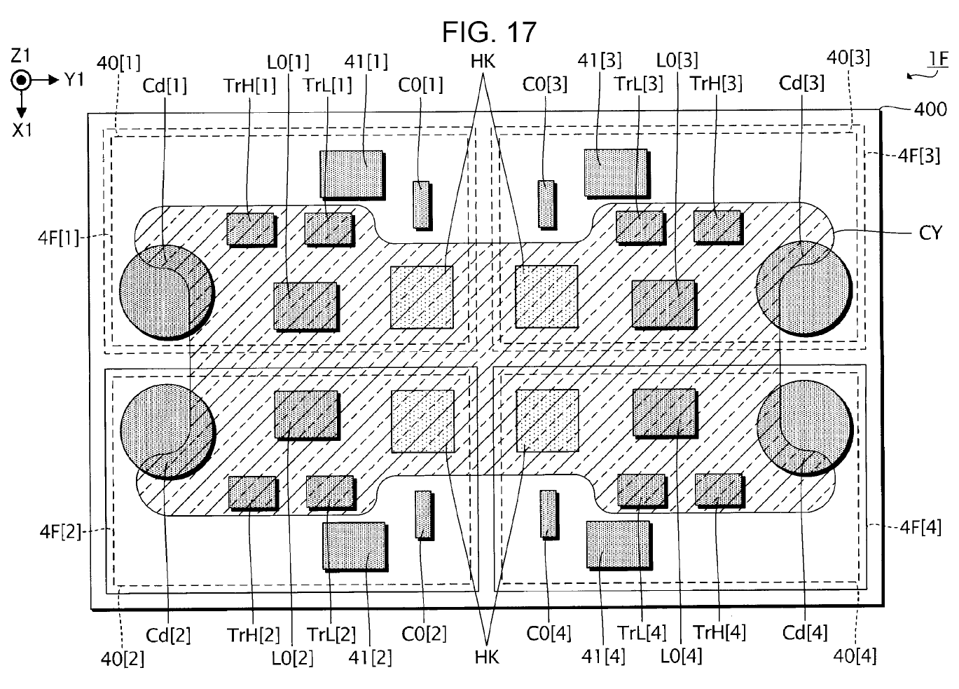

FIG. 17 is a plan view when four drive signal generation units 4F included in an ink jet printer 1F according to the present modification are viewed in the Z1 direction. In the present modification, the ink jet printer 1F is different from the ink jet printer 1 according to the embodiment in that the ink jet printer 1F includes the drive signal generation units 4F instead of the drive signal generation unit 4. Hereinafter, the q-th drive signal generation unit 4F among the four drive signal generation units 4F included in the ink jet printer 1F is referred to as a drive signal generation unit 4F[q]. In this case, the variable q is a natural number satisfying "1 ≤ q ≤ 4".

As illustrated in FIG. 17, each of the drive signal generation units 4F is different from the drive signal generation unit 4 according to the embodiment in that the drive signal generation unit 4F is disposed on the drive circuit substrate 400 common to the other drive signal generation units 4F and includes the thermally conductive clay CY common to the other drive signal generation units 4F. In other words, the ink jet printer 1F according to the present modification is different from the ink jet printer 1 according to the embodiment in that the thermally conductive clay CY is disposed in common to the four drive signal generation units 4F[1] to 4F[4] and that the drive circuit substrate 400 is disposed in common to the four drive signal generation units 4F[1] to 4F[4].

In the present modification, the drive signal generating circuit 40 included in the drive signal generation unit 4F[q] is referred to as a drive signal generating circuit 40[q]. In addition, in the present modification, a reference sign [q] is added to a reference sign for representing each electronic component included in the drive signal generating circuit 40[q]. In this case, in the present modification, the thermally conductive clay CY is disposed so as to cover electrolytic capacitors Cd[1] to Cd[4], transistors TrH[1] to TrH[4], transistors TrL[1] to TrL[4], and inductors L0[1] to L0[4].

In the present modification, the thermally conductive clay CY is disposed so as to cover one or a plurality of non-coating regions HK disposed on the drive circuit substrate 400. In the present modification, the thermally conductive clay CY is in contact with one or a plurality of heatsinks 5.

As described above, according to the present modification, the thermally conductive clay CY is in contact with the transistors TrH[1] to TrH[4], the transistors TrL[1] to TrL[4], and the inductors L0[1] to L0[4], and the thermally conductive clay CY is in contact with the electrolytic capacitors Cd[1] to Cd[4], the one or plurality of heatsinks 5, and the non-coating region HK. Therefore, according to the present modification, for example, heat generated from the drive signal generating circuits 40[1] to 40[4] can be efficiently dissipated through the thermally conductive clay CY, as compared to an aspect in which the thermally conductive clay CY is not disposed.

### B.6. Sixth Modification

In the above-described embodiments and the first to fifth modifications, the aspect in which the drive signal generation unit 4 is disposed separately from the head unit 3 has been described as an example, but the present disclosure is not limited to this aspect. The drive signal generation unit 4 may be mounted on the head unit 3.

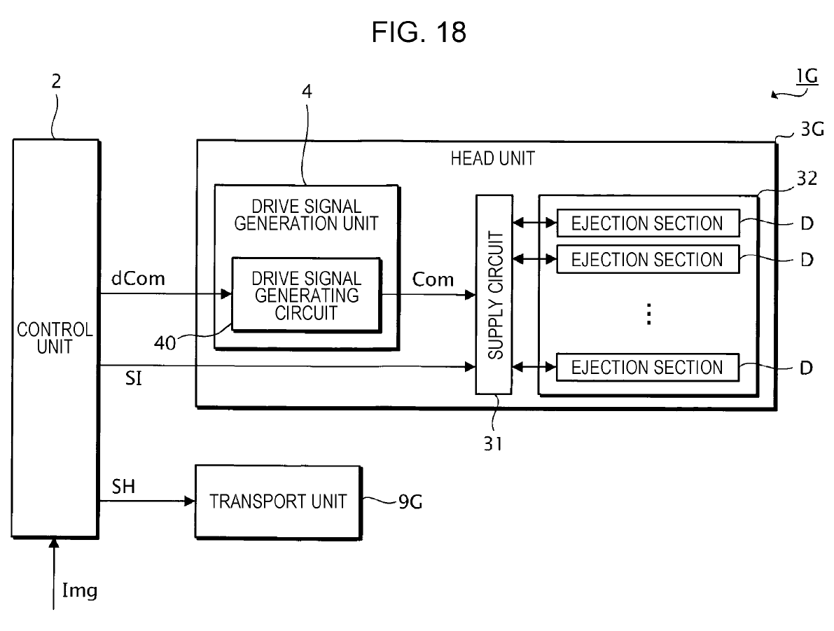

FIG. 18 is a functional block diagram illustrating an example of a configuration of an ink jet printer 1G according to the present modification.

As illustrated in FIG. 18, the ink jet printer 1G is different from the ink jet printer 1 according to the embodiment in that the ink jet printer 1G includes a head unit 3G instead of the head unit 3 and a transport unit 9G instead of the transport unit 9. The head unit 3G is different from the head unit 3 according to the embodiment in that the head unit 3G includes the drive signal generation unit 4 in addition to the supply circuit 31 and the head section 32. The transport unit 9G transports the recording sheet PP, but is different from the transport unit 9 according to the embodiment in that the transport unit 9G does not have a function of transporting the carriage 110 on which the head unit 3 is mounted. Specifically, the transport unit 9G is different from the transport unit 9 according to the embodiment in that the transport unit 9G does not include the carriage transport motor 91, the carriage guide shaft 96, and the belt 97.

Also in the present modification, similarly to the embodiments, heat generated from the drive signal generating circuit 40 can be efficiently dissipated through the thermally conductive clay CY.

### B.7. Seventh Modification

In the above-described embodiments and the first to sixth modifications, it is assumed that the ink jet printer 1 is a serial printer, but the present disclosure is not limited to this aspect. The ink jet printer 1 may be a so-called line printer in which a plurality of nozzles N are disposed in a head unit 3 so as to be arranged in a range wider than the width of the recording sheet PP. In this case, the head unit 3 does not reciprocate inside a housing 100, and the relative positional relationship between the head unit 3 and the housing 100 does not change.

### C. Supplementary Notes

Aspects related to the above description are appended below. In order to facilitate understanding of each of the aspects, in the following description, reference signs in the drawings are given in parentheses for convenience, but it is not intended that the present disclosure is limited to the aspects illustrated in the drawings.

### C.1. Supplementary Note 1

An ink jet printer 1 according to Supplementary Note 1 will be described below.

### Supplementary Note 1-1

A ink jet printer 1 according to Supplementary Note 1-1 includes an ejection section D that is driven by a drive signal Com and ejects ink, a drive circuit substrate 400 on which a drive signal generating circuit 40 that generates the drive signal Com is disposed, and thermally conductive clay CY that has an electrical insulation property and is a clay-like member, wherein the drive signal generating circuit 40 includes an electronic component that generates heat at the time of the generation of the drive signal Com by the drive signal generating circuit 40, and an electrolytic capacitor Cd, and the thermally conductive clay CY is in contact with the electronic component and the electrolytic capacitor Cd.

According to Supplementary Note 1-1, it is possible to simplify a configuration for cooling the electronic component, as compared to an aspect in which the drive signal generating circuit 40 is cooled using a heatsink designed in accordance with the height of the electronic component.

### Supplementary Note 1-2

An ink jet printer 1 according to Supplementary Note 1-2 is the ink jet printer 1 according to Supplementary Note 1-1, in which the drive signal generating circuit 40 includes a class-AB amplifier circuit, and the thermally conductive clay CY is in contact with a bipolar transistor TB1 and the electrolytic capacitor Cd that are included in the class-AB amplifier circuit.

### Supplementary Note 1-3

An ink jet printer 1 according to Supplementary Note 1-3 is the ink jet printer 1 according to Supplementary Note 1-1, in which the drive signal generating circuit 40 includes a class-D amplifier circuit and the thermally conductive clay CY is in contact with a transistor TrH and the electrolytic capacitor Cd that are included in the class-D amplifier circuit.

### Supplementary Note 1-4

An ink jet printer 1 according to Supplementary Note 1-4 is the ink jet printer 1 according to Supplementary Note 1-1, in which the drive signal generating circuit 40 includes a class-D amplifier circuit and a smoothing circuit, and the thermally conductive clay CY is in contact with an inductor L0 and the electrolytic capacitor Cd that are included in the smoothing circuit.

### Supplementary Note 1-5

An ink jet printer 1 according to Supplementary Note 1-5 is the ink jet printer 1 according to any one of Supplementary Notes 1-1 to 1-4, in which the electronic component and the electrolytic capacitor Cd that are in contact with the thermally conductive clay CY have different heights.

According to Supplementary Note 1-5, since heat is propagated from the electronic component to the electrolytic capacitor Cd by using the thermally conductive clay CY that is a clay-like member, even in a case where the electronic component and the electrolytic capacitor Cd are different in height, the electronic component can be cooled with a simple configuration.

### C.2. Supplementary Note 2

An ink jet printer 1 according to Supplementary Note 2 will be described below.

### Supplementary Note 2-1

An ink jet printer 1 according to Supplementary Note 2-1 includes an ejection section D that is driven by a drive signal Com and ejects ink, a drive circuit substrate 400 on which a drive signal generating circuit 40 that generates the drive signal Com is disposed, a heatsink 5 that cools the drive signal generating circuit 40, and thermally conductive clay CY that has an electrical insulation property and is a clay-like member, wherein the thermally conductive clay CY includes a base material made of silicone clay SL, and a thermally conductive particle PT added to the base material, and is in contact with the drive signal generating circuit 40 and the heatsink 5.

According to Supplementary Note 2-1, since the thermally conductive clay CY is in contact with the drive signal generating circuit 40, it is possible to cool the drive signal generating circuit 40 by the heatsink 5 having a simple configuration, as compared to an aspect in which the drive signal generating circuit 40 is cooled using a heatsink designed in accordance with the height of the drive signal generating circuit 40.

### Supplementary Note 2-2

An ink jet printer 1 according to Supplementary Note 2-2 is the ink jet printer 1 according to Supplementary Note 2-1, in which the drive circuit substrate 400 includes a clay-disposed region AR1 including a surface covered with the thermally conductive clay CY and a clay-free region AR2 including a surface that is not covered with the thermally conductive clay CY, the surface of the clay-disposed region AR1 includes a non-coating region HK that is not coated with an insulating resist member 401R, and the surface of the clay-free region AR2 is coated with the insulating resist member 401R.

According to Supplementary Note 2-2, since the thermally conductive clay CY is a clay-like member and can achieve high adhesion between the thermally conductive clay CY and the drive circuit substrate 400, the drive circuit substrate 400 can be protected by the thermally conductive clay CY even in a case where the drive circuit substrate 400 is not protected by the resist member 401R in the non-coating region HK. In addition, according to Supplementary Note 2-2, since the thermally conductive clay CY is in contact with the non-coating region HK, heat generated from the drive signal generating circuit 40 can be dissipated through the drive circuit substrate 400.

### Supplementary Note 2-3

An ink jet printer 1 according to Supplementary Note 2-3 is the ink jet printer 1 according to Supplementary Note 2-2, in which in the non-coating region HK, a wiring line 401L disposed in a surface layer 401 included in the drive circuit substrate 400 is in contact with the thermally conductive clay CY.

According to Supplementary Note 2-3, since the thermally conductive clay CY is in contact with the non-coating region HK, heat generated from the drive signal generating circuit 40 can be dissipated through the drive circuit substrate 400.

### Supplementary Note 2-4

An ink jet printer 1 according to Supplementary Note 2-4 is the ink jet printer 1 according to Supplementary Note 2-3, in which a plurality of wiring lines 401L are disposed in the surface layer 401 and a diameter of the thermally conductive particle PT is less than an interval between two wiring lines 401L adjacent to each other among the plurality of wiring lines 401L.

According to Supplementary Note 2-4, it is possible to prevent the two wiring lines 401L adjacent to each other from being electrically coupled to each other due to the thermally conductive particle PT in the thermally conductive clay CY, and to secure the electrical insulation of the thermally conductive clay CY in the drive signal generating circuit 40.

### Supplementary Note 2-5

An ink jet printer 1 according to Supplementary Note 2-5 is the ink jet printer 1 according to any one of Supplementary Notes 2-1 to 2-4, in which a plurality of drive signal generating circuits 40 are disposed on the drive circuit substrate 400, and the thermally conductive clay CY is disposed so as to cover the plurality of drive signal generating circuits 40.

According to Supplementary Note 2-5, it is possible to simplify a configuration for cooling the drive signal generating circuits 40, as compared to an aspect in which the thermally conductive clay CY is disposed for each of the plurality of drive signal generating circuits 40.

### Supplementary Note 2-6

An ink jet printer 1 according to Supplementary Note 2-6 is the ink jet printer 1 according to any one of Supplementary Notes 2-1 to 2-5, in which the drive signal generating circuit 40 includes a plurality of electronic components having different heights and the thermally conductive clay CY covers the plurality of electronic components.

According to Supplementary Note 2-6, since the thermally conductive clay CY that is a clay-like member is in contact with the plurality of electronic components having the different heights, it is possible to cool the plurality of electronic components. Therefore, the drive signal generating circuit 40 can be cooled with a simple configuration, as compared to an aspect in which the drive signal generating circuit 40 is cooled using a heatsink designed in accordance with the height of the drive signal generating circuit 40.

### Supplementary Note 2-7

An ink jet printer 1 according to Supplementary Note 2-7 is the ink jet printer 1 according to any one of Supplementary Notes 2-1 to 2-6, in which the heatsink 5 has a planar portion 5000 and the thermally conductive clay CY is in contact with the heatsink 5 at the planar portion 5000.

According to Supplementary Note 2-7, the drive signal generating circuit 40 can be cooled with a simple configuration, as compared to an aspect in which the drive signal generating circuit 40 is cooled using a heatsink designed in accordance with the height of the drive signal generating circuit 40.

What is claimed is:

1. A liquid ejecting apparatus comprising:
an ejection section that is driven by a drive signal and ejects liquid;
a circuit substrate on which a drive circuit that generates the drive signal is disposed;
a heatsink that cools the drive circuit; and
a clay-like thermally conductive member having an electrical insulation property, wherein
the thermally conductive member includes a base material made of silicone clay, and a thermally conductive particle added to the base material, and is in contact with the drive circuit and the heatsink.

2. The liquid ejecting apparatus according to claim 1, wherein
the circuit substrate includes
a first region including a surface covered with the thermally conductive member, and
a second region including a surface that is not covered with the thermally conductive member,
the surface of the first region includes a non-coating region that is not coated with an insulating resist member, and
the surface of the second region is coated with the insulating resist member.

3. The liquid ejecting apparatus according to claim 2, wherein
in the non-coating region, a wiring line disposed in a wiring layer included in the circuit substrate is in contact with the thermally conductive member.

4. The liquid ejecting apparatus according to claim 3, wherein
a plurality of wiring lines are disposed in the wiring layer, and
a diameter of the thermally conductive particle is less than an interval between two wiring lines adjacent to each other among the plurality of wiring lines.

5. The liquid ejecting apparatus according to claim 1, wherein
a plurality of drive circuits including the drive circuit are disposed on the circuit substrate, and
the thermally conductive member covers the plurality of drive circuits.

6. The liquid ejecting apparatus according to claim 1, wherein
the heatsink has a planar portion, and
the thermally conductive member is in contact with the heatsink at the planar portion.

7. The liquid ejecting apparatus according to claim 1, wherein
the drive circuit includes a plurality of electronic components having different heights, and
the thermally conductive member covers the plurality of electronic components.

8. A head unit comprising:
an ejection section that is driven by a drive signal and ejects liquid;
a circuit substrate on which a drive circuit that generates the drive signal is disposed;
a heatsink that cools the drive circuit; and
a clay-like thermally conductive member having an electrical insulation property, wherein
the thermally conductive member includes a base material made of silicone clay, and a thermally conductive particle added to the base material, and is in contact with the drive circuit and the heatsink.

9. The head unit according to claim 8, wherein
the circuit substrate includes
a first region including a surface covered with the thermally conductive member, and
a second region including a surface that is not covered with the thermally conductive member,
the surface of the first region includes a non-coating region that is not coated with an insulating resist member, and
the surface of the second region is coated with the insulating resist member.

10. The head unit according to claim 9, wherein
in the non-coating region, a wiring line disposed in a wiring layer included in the circuit substrate is in contact with the thermally conductive member.

11. The head unit according to claim 10, wherein
a plurality of wiring lines are disposed in the wiring layer, and
a diameter of the thermally conductive particle is less than an interval between two wiring lines adjacent to each other among the plurality of wiring lines.

12. The head unit according to claim 8, wherein
a plurality of drive circuits including the drive circuit are disposed on the circuit substrate, and
the thermally conductive member covers the plurality of drive circuits.

13. The head unit according to claim 8, wherein
the heatsink has a planar portion, and
the thermally conductive member is in contact with the heatsink at the planar portion.

14. The head unit according to claim 8, wherein
the drive circuit includes a plurality of electronic components having different heights, and
the thermally conductive member covers the plurality of electronic components.
